(19) United States
(12) Patent Application Publication
(10) Pub. No.: US 2024/0039046 A1
(43) Pub. Date: Feb. 1, 2024

(54) MODIFIED DOPO BASED BATTERY ELECTROLYTE ADDITIVES

(71) Applicant: NOHMS Technologies, Inc., Rochester, NY (US)

(72) Inventors: Gabriel Torres, Rochester, NY (US); John Sinicropi, Rochester, NY (US); Surya S. Moganty, Henrietta, NY (US); Rutvik Vaidya, Rochester, NY (US)

(21) Appl. No.: 18/357,537

(22) Filed: Jul. 24, 2023

Related U.S. Application Data
(60) Provisional application No. 63/392,029, filed on Jul. 25, 2022.

(51) Int. Cl. H01M 10/0567; H01M 10/0525

(52) U.S. Cl. CPC H01M 10/0567; H01M 10/0525; H01M 2300/0025

(57) ABSTRACT

An electrolyte containing a DOPO-based molecule; an aprotic organic solvent; and a metal salt and an electrochemical energy storage device containing the electrolyte is disclosed.

### CROSS REFERENCE

This application claims the benefit of the filing date of U.S. Provisional Patent Application No. 63/392,029, filed Jul. 25, 2022, which is hereby incorporated by reference in its entirety.

### FIELD

The disclosure is directed towards phosphorous based 9,10-dihydro-9-oxa-10-organylphosphaphenanthrene-10-oxide derivatives (DOPO) as electrolyte additives and an electrolyte for electrochemical cells containing the DOPO molecules.

### BACKGROUND

Li-ion batteries are heavily used in consumer electronics, electric vehicles (EVs), as well as energy storage systems (ESS) and smart grids. Recently, Li-ion batteries with voltages above 4.35 V have gained importance because of higher capacity and subsequent energy density benefits. However, the stability of the cathode materials at these potentials reduces due to increased oxidation. This may result in electrochemical oxidation of the material to produce gases, and that can deteriorate the performance of the battery. The cathode active material, which is capable of intercalating/deintercalating lithium ions may dissolve in the non-aqueous electrolyte, resulting in a structural breakdown of the material, and will lead to an increase in the interfacial resistance. These Li-ion batteries are also typically exposed to extreme temperatures during their operation. The SEI (Solid Electrolyte Interface) layer formed on the anode is gradually broken down at high temperatures, and hence leads to more irreversible reaction resulting in capacity loss. Similarly, the CEI (Cathode Electrolyte Interface) will also lose stability at elevated temperatures. These reactions happen on the positive and negative electrode during cycling but are generally more severe at higher temperatures due to faster kinetics. The next generation Li-ion batteries used in consumer electronics, EVs, and ESS will require significant improvements in the electrolyte component relative to the current state-of-the art of Li-ion batteries.

The shuttling of positive and negative ions between the battery electrodes is the main function of the electrolyte. Historically, researchers have focused on developing battery electrodes, and electrolyte development has been limited. Traditional Li-ion batteries used carbonate-based electrolytes with a large electrochemical window, that can transport lithium ions. These electrolytes need functional additives to passivate the anode and form a stable SEI, as well as additives for stabilizing the cathode. At the same time, there is a need to design and develop compounds that allow stable and safe cycling of high voltage, high energy Li-ion batteries.

As the industry moves towards higher energy cathode materials for higher energy batteries, stable, efficient, and safe cycling of batteries in wide voltage windows is necessary. Li-ion battery electrolytes can be tuned based on their applications by addition of different co-solvents and additives. This tunability has enabled the development of different additives for high voltage stability and safety of Li-ion cells.

To keep up with this development, battery electrolytes need functional additives to extend the voltage stability of liquid electrolytes. U.S. Pat. No. 8,993,158 to Mitsui has reported the use of silyl group containing phosphonic acid derivatives in Li-ion electrolytes. U.S. Pat. Nos. 7,494,746 and 8,945,776 to Samsung SDI has reported the use of silyl group containing phosphites and borates as Li-ion battery electrolyte additives. U.S. patent Ser. No. 10/497,975 B2 and U.S. Patent Application Nos. 20180076483 A1 and 20190089000 A1 by Shenzhen Capchem demonstrate the use of propargyl phosphate esters in lithium-ion battery electrolytes. U.S. Pat. No. 4,198,492 to Asahi-Dow teaches the use of DOPO-based molecules as flame retardants.

### SUMMARY

Herein, derivatives of 9,10-dihydro-9-oxa-10-organylphosphaphenanthrene-10-oxide (DOPO) molecules are reported as additives for Li-ion batteries. These molecules as electrolyte additives allow for stabilization of the cathode and the holistic electrolyte system. The cell with functionalized cyclic ethers in the electrolyte would enable safe, long cycle life, and high energy lithium-ion batteries.

In accordance with one aspect of the present disclosure, there is provided a new class of compounds, and an electrolyte for an electrochemical energy storage device. The electrolyte includes: a DOPO-based molecule; an aprotic organic solvent; and a metal salt.

In accordance with another aspect of the present disclosure, there is provided an electrolyte for an electrochemical energy storage device, the electrolyte includes: a DOPO-based molecule; an aprotic organic solvent; a metal salt; and at least one additive.

In accordance with another aspect of the present disclosure, there is provided an electrochemical energy storage device, including: a cathode; an anode; a separator and an electrolyte including a DOPO-based molecule; an aprotic organic solvent, and a metal salt.

In accordance with another aspect of the present disclosure, there is provided an electrolyte for an electrochemical energy storage device, the electrolyte includes: a DOPO-based molecule; an aprotic organic solvent; a metal salt; and at least one additive, wherein the aprotic organic solvent includes open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof.

In accordance with another aspect of the present disclosure, there is provided an electrolyte for an electrochemical energy storage device, the electrolyte includes: a DOPO-based molecule; an aprotic organic solvent; a metal salt; and at least one additive, wherein the cation of the metal salt is aluminum, magnesium or an alkali metal, such as lithium or sodium.

In accordance with another aspect of the present disclosure, there is provided an electrolyte for an electrochemical energy storage device, the electrolyte includes: a DOPO-based molecule; an aprotic organic solvent; a metal salt; and at least one additive, wherein the additive contains a compound containing at least one unsaturated carbon-carbon bond, carboxylic acid anhydride, sulfur-containing compound, phosphorus-containing compounds boron-containing compound, silicon-containing compound or mixtures thereof.

These and other aspects of the present disclosure will become apparent upon a review of the following detailed description and the claims appended thereto.

### BRIEF DESCRIPTION OF DRAWINGS

FIG. 1 shows the dQ/dV profiles of electrolytes tested in NMC622/Gr cells;

FIG. 2 shows the room temperature cycle life characteristics of electrolytes tested in NMC622/Gr cells; and

FIG. 3 shows the dQ/dV profiles of electrolytes tested in NMC811/Gr cells.

### DETAILED DESCRIPTION

The disclosed technology relates generally to lithium-ion (Li-ion) battery electrolytes. Particularly, the disclosure is directed towards DOPO-based molecules with silyl-based groups or unsaturated terminal groups; electrolytes containing these compounds; and electrochemical energy storage devices containing these electrolytes. The shorthand, DOPO, is defined as referring to derivatives of 9,10-dihydro-9-oxa-10-organylphosphaphenanthrene-10-oxide. Silyl-based functional groups, unsaturated terminal groups, and organic cationic moieties can be covalently bonded to DOPO to generate novel DOPO-based molecules, and hence there is a need to create DOPO-based molecules to improve the performance of Li-ion batteries.

Herein, DOPO-based molecules with silyl-based groups, unsaturated terminal groups or organic cationic moieties, are disclosed for use in electrolytes for next generation Li-ion batteries. 9,10-dihydro-9-oxa-10-organylphosphaphenanthrene-10-oxide (DOPO) derivatives have been used for their flame-retardant properties, but different functional groups can be appended to the core DOPO structure to design molecules with different properties. The DOPO derived compounds with silyl-based groups and unsaturated terminal groups according to the present disclosure have high solubility in organic solvents and can be used in electrolytes. Organic cationic moieties can also be covalently bonded to the DOPO structure to form an overall ionic compound.

By adding silyl moieties in the Li-ion battery electrolytes, a more stable silicon-containing film or layer can be formed more easily on the electrode materials, and in some cases such groups can also act as H₂O scavengers. Unsaturated terminal groups like allyl, propargyl, and vinyl groups can also induce polymerization onto an electrode surface, thus increasing the resistance. This forms a film or a network on the electrode surface, and hence long-term performance improves. The film prevents the electrolyte-electrode reaction, which results in lower gas generation during high temperature storage and cycling operations. Incorporating organic cationic moieties ionically bonded to an anion onto the DOPO structure creates a salt, providing it inherent nonflammable and improved solubility in conventional solvents.

In an embodiment, an electrochemical energy storage device electrolyte includes a) an aprotic organic solvent system; b) a metal salt; c) a DOPO-based molecule with silyl-based groups, unsaturated terminal groups, or organic cationic moieties; and d) an at least one additive.

In an aspect of the disclosure, the molecular structures of DOPO-based organic compounds according to Formula I are depicted below:

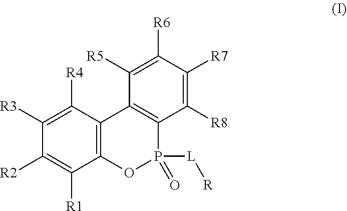

wherein:
R₁-R₈ each can be independently halogens, C₁-C₁₂ substituted and unsubstituted alkyl and fluoroalkyl groups, or C₆-C₁₄ aryl groups wherein the hydrogen atoms can be replaced by a halogen, alkyl, alkoxy, perfluorinated alkyl, silyl, siloxy, silane, sulfoxide, sulfonyl, amide, azo, ether, thioether group or combinations thereof;

L is (a) a linker, including a C₁-C₈ alkyl, alkenyl, alkynyl, alkoxy, ester, carbonyl, phenyl, thioether, sulfoxide, sulfonyl, azo or aryl group, wherein any of the carbon atoms therein are optionally further substituted with or hydrogen atoms replaced by a halide; (b) O or S; or (c) O or S attached to the linker; and

R is C₁-C₁₂ substituted or unsubstituted alkyl or fluoroalkyl groups, or C₆-C₁₄ aryl groups, wherein the hydrogen atoms can be replaced by a halogen, alkyl, alkoxy, perfluorinated alkyl, silyl, siloxy, silane, sulfoxide, sulfonyl, amide, azo, ether, thioether group or combinations thereof; or

R is C₁-C₁₂ substituted or unsubstituted alkyl or fluoroalkyl groups, or C₆-C₁₄ aryl groups, terminating in an unsaturated group, wherein the hydrogen atoms can be replaced by a halogen, alkyl, alkoxy, perfluorinated alkyl, silyl, siloxy, silane, sulfoxide, sulfonyl, amide, azo, ether, thioether group or combinations thereof, or

R is a silane, wherein the hydrogen atoms can be replaced by a halogen, alkyl, alkoxy, perfluorinated alkyl, silyl, siloxy, silane, sulfoxide, sulfonyl, amide, azo, ether, thioether group or combinations thereof; or

R is an organic cation ionically bonded to an anion, where the cation is either a sulfonium, phosphonium, or a 5- or 6-membered cationic heterocyclic ring having 1 to 3 heteroatoms as ring members including nitrogen, oxygen, silicon, or sulfur and, where the anion is either a halide, nitrate, phosphate, imide, borate, aluminate, arsenide, cyanide, thiocyanate, nitrite, benzoate, carbonate, chlorate, chlorite, chromate, sulfate, sulfite, silicate, thiosulfate, chalcogenide, pnictogenide, oxalate, acetate, formate or hydroxide.

In an embodiment, the unsaturated terminal group can be selected from a group consisting of alkenyl and alkynyl groups such as allyl, propargyl, vinyl, and styrenic groups.

In another embodiment, the DOPO-based molecule is present in the electrolyte in a range of from 0.01% to 10% by weight.

The disclosure also includes a method for synthesizing the DOPO-based molecule with silyl-based groups or unsaturated terminal groups, and the use of such molecules in lithium-ion battery electrolytes. These molecules improve cycle life and storage characteristics of Li-ion cells operated and stored at high voltages and high-temperatures.

In an aspect of the disclosure, the electrolyte includes a metal salt in a range of 10% to 30% by weight. In an embodiment, the cation of the metal salt contains lithium, sodium, aluminum or magnesium. A variety of lithium salts may be used, including, for example, Li(AsF₆); Li(PF₆); Li(CF₃CO₂); Li(C₂F₅CO₂); Li(CF₃SO₃); Li[N(CP₃SO₂)₂]; Li[C(CF₃SO₂)₃]; Li[N(SO₂C₂F₅)₂]; Li(ClO₄); Li(BF₄); Li(PO₂F₂); Li[PF₂(C₂O₄)₂]; Li[PF₄C₂O₄]; lithium alkyl fluorophosphates; Li[B(C₂O₄)₂]; Li[BF₂C₂O₄]; Li₂[B₁₂Z₁₂₋ⱼHⱼ]; Li₂[B₁₀X_{1o-j′}H_{j′}]; or a mixture of any two or more thereof, wherein Z is independent at each occurrence a halogen, j is an integer from 0 to 12 and j′ is an integer from 1 to 10.

In an aspect of the disclosure, the electrolyte includes an aprotic organic solvent. The solvent may be present in a range of from 60% to 90% by weight of the electrolyte. The solvent can be selected from open-chain or cyclic carbonate, carboxylic acid ester, nitrite, ether, sulfone, sulfoxide, ketone, lactone, dioxolane, glyme, crown ether, siloxane, phosphoric acid ester, phosphite, mono- or polyphosphazene or mixtures thereof.

Examples of aprotic solvents for generating electrolytes include but are not limited to dimethyl carbonate, ethyl methyl carbonate, diethyl carbonate, methyl propyl carbonate, ethyl propyl carbonate, dipropyl carbonate, propylene carbonate, ethylene carbonate, fluoroethylene carbonate, bis(trifluoroethyl) carbonate, bis(pentafluoropropyl) carbonate, trifluoroethyl methyl carbonate, pentafluoroethyl methyl carbonate, heptafluoropropyl methyl carbonate, perfluorobutyl methyl carbonate, trifluoroethyl ethyl carbonate, pentafluoroethyl ethyl carbonate, heptafluoropropyl ethyl carbonate, perfluorobutyl ethyl carbonate, etc., fluorinated oligomers, methyl propionate, ethyl propionate, butyl propionate, dimethoxyethane, triglyme, dimethylvinylene carbonate, tetraethyleneglycol, dimethyl ether, polyethylene glycols, triphenyl phosphate, tributyl phosphate, hexafluorocyclotriphosphazene, 2-Ethoxy-2,4,4,6,6-pentafluoro-1,3,5,2-5,4-5,6-5 triazatriphosphinine, triphenyl phosphite, sulfolane, dimethyl sulfoxide, ethyl methyl sulfone, ethylvinyl sulfone, allyl methyl sulfone, divinyl sulfone, fluorophenylmethyl sulfone and gamma-butyrolactone.

In an aspect of the disclosure, the electrolytes further include at least one additive to protect the electrodes and electrolyte from degradation. Thus, electrolytes of the present technology may include an additive that is reduced or polymerized on the surface of an electrode to form a passivation film on the surface of the electrode.

In an embodiment, the at least one additive is a substituted or unsubstituted linear, branched, or cyclic hydrocarbon including at least one oxygen atom and at least one aryl, alkenyl or alkynyl group. The passivating film formed from such additives may also be formed from a substituted aryl compound or a substituted or unsubstituted heteroaryl compound where the additive includes at least one oxygen atom.

Representative additives include glyoxal bis(diallyl acetal), tetra(ethylene glycol) divinyl ether, 1,3,5-triallyl-1,3,5-triazine-2,4,6(1H,3H,5H)-trione, 1,3,5,7-tetravinyl-1,3,5,7-tetramethylcyclotetrasiloxane, 2,4,6-triallyloxy-1,3,5-triazine, 1,3,5-triacryloylhexahydro-1,3,5-triazine, 1,2-divinyl furoate, 1,3-butadiene carbonate, 1-vinylazetidin-2-one, 1-vinylaziridin-2-one, 1-vinylpiperidin-2-one, 1 vinylpyrrolidin-2-one, 2,4-divinyl-1,3-dioxane, 2-amino-3-vinylcyclohexanone, 2-amino-3-vinylcyclopropanone, 2 amino-4-vinylcyclobutanone, 2-amino-5-vinylcyclopentanone, 2-aryloxy-cyclopropanone, 2-vinyl-[1,2]oxazetidine, 2 vinylaminocyclohexanol, 2-vinylaminocyclopropanone, 2-vinyloxetane, 2-vinyloxy-cyclopropanone, 3-(N-vinylamino)cyclohexanone, 3,5-divinyl furoate, 3-vinylazetidin-2-one, 3 vinylaziridin-2-one, 3-vinylcyclobutanone, 3-vinylcyclopentanone, 3-vinyloxaziridine, 3-vinyloxetane, 3-vinylpyrrolidin-2-one, 2-vinyl-1,3-dioxolane, acrolein diethyl acetal, acrolein dimethyl acetal, 4,4-divinyl-3-dioxolan-2-one, 4-vinyltetrahydropyran, 5-vinylpiperidin-3-one, allylglycidyl ether, butadiene monoxide, butyl-vinyl-ether, dihydropyran-3-one, divinyl butyl carbonate, divinyl carbonate, divinyl crotonate, divinyl ether, divinyl ethylene carbonate, divinyl ethylene silicate, 1,3 propane sultone, 1,3 propene sultone, divinyl ethylene sulfate, divinyl ethylene sulfite, divinyl methoxypyrazine, divinyl methylphosphate, divinyl propylene carbonate, ethyl phosphate, methoxy-o-terphenyl, methyl phosphate, oxetan-2-yl-vinylamine, oxiranylvinylamine, vinyl carbonate, vinyl crotonate, vinyl cyclopentanone, vinyl ethyl-2-furoate, vinyl ethylene carbonate, 4-fluoro-1,3-dioxolan-2-one, vinyl ethylene silicate, vinyl ethylene sulfate, vinyl ethylene sulfite, vinyl methacrylate, vinyl phosphate, vinyl-2-furoate, vinylcylopropanone, vinylethylene oxide, β-vinyl-γ-butyrolactone or a mixture of any two or more thereof. In some embodiments, the additive may be a cyclotriphosphazene that is substituted with F, alkyloxy, alkenyloxy, aryloxy, methoxy, allyloxy groups or combinations thereof. For example, the additive may be a (divinyl)-(methoxy)(trifluoro)cyclotriphosphazene, (trivinyl)(difluoro)(methoxy)cyclotriphosphazene, (vinyl)(methoxy)(tetrafluoro)cyclotriphosphazene, (aryloxy)(tetrafluoro)(methoxy)cyclotriphosphazene or (diaryloxy)(trifluoro)(methoxy)cyclotriphosphazene compounds or a mixture of two or more such compounds.

In some embodiments the additive is a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride or the mixtures thereof. In some embodiments, the additive is vinyl carbonate, vinyl ethylene carbonate, or a mixture of any two or more such compounds.

In another aspect of the disclosure, an electrochemical energy storage device is provided that includes a cathode, an anode and an electrolyte including a DOPO-based molecule as described herein. In one embodiment, the electrochemical energy storage device is a lithium secondary battery. In some embodiments, the secondary battery is a lithium battery, a lithium-ion battery, a lithium-sulfur battery, a lithium-air battery, a sodium ion battery, or a magnesium battery. In some embodiments, the electrochemical energy storage device is an electrochemical cell, such as a capacitor. In some embodiments, the capacitor is an asymmetric capacitor or supercapacitor. In some embodiments, the electrochemical cell is a primary cell. In some embodiments, the primary cell is a lithium/MnO₂ battery or Li/poly(carbon monofluoride) battery. In some embodiments, the electrochemical energy storage device is a solar cell.

In an embodiment, a secondary battery is provided including a positive and a negative electrode separated from each other using a porous separator and the electrolyte described herein.

Suitable cathode materials for a secondary battery including the electrolyte described herein include those such as, but not limited to, vanadium oxide, lithium peroxide, sulfur, polysulfide, a lithium carbon monofluoride (also known as LiCFₓ) or mixtures of any two or more thereof, carbon-coated olivine cathodes such as LiFePO₄, lithium metal oxides such LiCoO₂, LiNiO₂, LiNiₓCo_{y}Met_{z}O₂, LiMn_{0.5}Ni_{0.5}O₂, LiMn_{0.1}Co_{0.1}Ni_{0.8}O₂, LiMn_{0.2}Co_{0.2}Ni_{0.6}O₂, LiMn_{0.3}Co_{0.2}Ni_{0.5}O₂, LiMn_{0.33}Co_{0.33}Ni_{0.33}O₂, LiMn₂O₄, LiFeO₂, Li_{1+x′}Ni_{α}Mn_{β}Co_{γ}Met'_{δ}O_{2-z′}, F_{z′}, or A_{n′}B₂(XO₄)₃, wherein Met is Al, Mg, Ti, B, Ga, Si, Mn or Co; Met′ is Mg, Zn, Al, Ga, B, Zr or Ti; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, 0≤z≤0.5, 0≤x′≤0.4, 0≤α≤1, 0≤β≤1, 0≤γ≤1, 0≤δ≤0.4, 0≤z′≤0.4 and 0≤n′≤3. In other embodiments, an olivine cathode has a formula of Li₁₊ₓFe_{1z}Met″_{y}PO₄₋ₘX′ₙ, wherein Met″ is Al, Mg, Ti, B, Ga, Si, Ni, Mn or Co; X is S or F; and wherein 0≤x≤0.3, 0 0≤y≤0.5, 0≤z≤0.5, 0≤m≤0.5 and 0≤n≤0.5.

Suitable anodes include those such as lithium metal, graphitic materials, amorphous carbon, carbon nanotubes, Li₄Ti₅O₁₂, tin alloys, silicon, silicon alloys, intermetallic compounds, or mixtures of any two or more such materials. Suitable graphitic materials include natural graphite, artificial graphite, graphitized meso-carbon microbeads (MCMB) and graphite fibers, as well as any amorphous carbon materials. In some embodiments, the anode and cathode electrodes are separated from each other by a porous separator.

The separator for the lithium battery may be a microporous polymer film. Examples of polymers for forming films include polypropylene, polyethylene, nylon, cellulose, nitrocellulose, polysulfone, polyacrylonitrile, polyvinylidene fluoride, polybutene, or copolymers or blends of any two or more such polymers. In some instances, the separator is an electron beam-treated micro-porous polyolefin separator. The electron treatment can increase the deformation temperature of the separator and can accordingly enhance thermal stability at high temperatures. Additionally, or alternatively, the separator can be a shut-down separator. The shut-down separator can have a trigger temperature above about 130° C. to permit the electrochemical cells to operate at temperatures up to about 130° C.

The disclosure will be further illustrated with reference to the following specific examples. It is understood that these examples are given by way of illustration and are not meant to limit the disclosure or the claims to follow.

### Example A—Synthesis of 10-Mercaptopropyl TEOS-9,10-dihydro-9-oxa-10-Phosphaphenanthrene-10-oxide

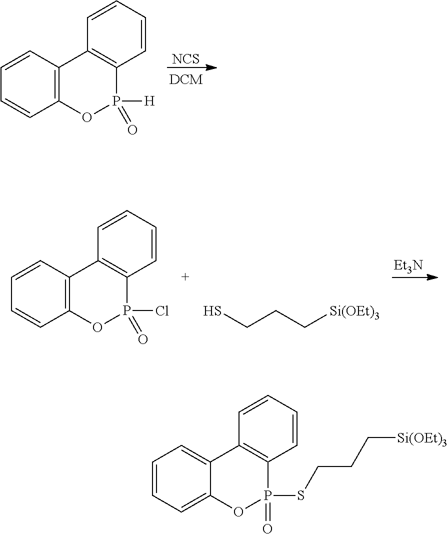

A 250 mL flask equipped with a magnetic stirrer, addition funnel, nitrogen inlet and thermocouple was charged with 10 g DOPO in 100 mL dichloromethane (DCM). The flask was cooled in an ice water bath to 10° C. To the cold slurry, 6.8 g N-Chlorosuccinimide (NCS) was added portion wise, keeping the temperature under 15° C. The ice water bath was removed, and the slurry was stirred under nitrogen. As the reaction warmed an exotherm began to occur. After 30 min the temperature had risen to about 40° C. and the solid had begun to go into solution. The reaction was stirred an additional 30 min at which time everything was in solution and the temperature was about 24° C. TLC (Ethyl Acetate 50%/Hexanes 50%) showed no starting material and one major new spot. The solution was then cooled to 8° C. To the cold solution, 11.0 g Mercaptopropyltriethoxysilane and 4.7 g triethylamine in 30 to 40 mL DCM was added dropwise over 20 min, keeping the temperature under 15° C. TLC showed no starting chloride and one new spot that moves as expected. The reaction was allowed to come to room temperature. The entire reaction was then placed on a pad of silica gel and eluted with DCM 85%/Ethyl Acetate 15%. Concentrated to a white gum. Slurred in 80 mL Ethyl Acetate/Hexanes 60% mixture overnight. Filtered and air dried. Collected: white solid, 7 g, 33.5% yield.
FTIR: 1476.28; 1303.27; 1198.23; 907.74; 750.95; 713.27; 602.69; 509.76 cm-1.

### Example B—Synthesis of 10-Mercaptopropyl TMOS-9,10-dihydro-9-oxa-10-Phosphaphenanthrene-10-oxide

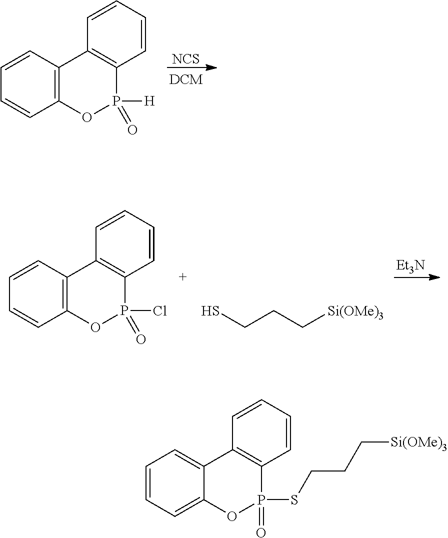

A 250 mL flask equipped with a magnetic stirrer, addition funnel, nitrogen inlet and thermal couple was charged with 10 g DOPO in 100 mL DCM. The flask was cooled in an ice water bath to 10° C. To the cold slurry, 6.8 g NCS was added portion wise, keeping the temperature under 15° C. The ice bath was removed, and the slurry was stirred under nitrogen. As the reaction warmed an exotherm began to occur. After 30 min the temperature had risen to about 40° C. and the solid had begun to go into solution. The reaction was stirred an additional 30 min at which time everything was in solution and the temperature was about 24° C. TLC (Ethyl Acetate 50%/Hexanes 50%) shows no starting material and one major new spot. The solution was then cooled to about 8° C. To the cold solution, 9.1 g (3-Mercaptopropyl)trimethoxysilane and 4.7 g triethylamine in 30 to 40 mL DCM was added dropwise over 20 min, keeping the temperature under 15° C. TLC showed no starting chloride and one new spot that moves as expected. The reaction was allowed to come to room temperature. The entire reaction was then placed on a pad of silica gel and eluted with DCM 85%/Ethyl Acetate 15% up to 20% Ethyl Acetate. Concentrated to a white gum. Slurred in 80 mL Ethyl Acetate/Hexanes 60% mixture overnight to give a white solid. Filtered and air dried. Collected: 6.1 g, white solid, 51.3% yield. FTIR: 1738.41; 1302.94; 1200.42; 946.55, 907.57; 750.91; 713.02; 602.33; 509.73 cm-1.

### Example C—Synthesis of 10-Propargyl-9,10-dihydro-9-oxa-10-Phosphaphenanthrene-10-oxide

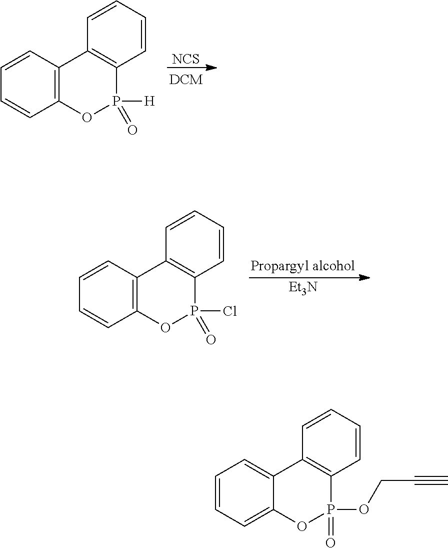

A 250 mL flask equipped with a magnetic stirrer, addition funnel, nitrogen inlet and thermal couple was charged with 10 g DOPO in 100 mL DCM. The flask was cooled in an ice water bath to 8.8° C. To the cold slurry, 6.8 g NCS was added portion wise, keeping the temperature under 15° C. The ice water bath was removed, and the slurry was stirred under nitrogen. As the reaction warmed an exotherm began to occur. After 30 min, the temperature had risen to about 40° C. and the solid had begun to go into solution. The reaction stirred an additional 30 min at which time everything was in solution and the temperature was about 24° C. TLC (Ethyl Acetate 50%/Hexanes 50%) shows no starting material and one major new spot. The solution was then cooled to 8° C. To the cold solution, 6.6 g propargyl alcohol and 5.6 g triethylamine in 20 mL DCM was added dropwise over 20 minutes, keeping the temperature under 15° C. TLC showed no starting chloride and one new spot that moves as expected. The reaction was allowed to come to room temperature. The entire reaction was then placed on a pad of silica gel and eluted with DCM 90%/Ethyl Acetate 10%. Concentrated to a white gum. Slurred in 80 mL of Ethyl Acetate 50%/Hexanes mixture for overnight. Filtered and air dried. Collected: white solid, 6.1 g, 51.3% yield.
FTIR: 1688.53, 1684.10; 1294.21; 1192.85; 909.61; 751.91; 638.51; 510.17 cm-1.

Further specific examples of suitable DOPO-based molecules according to the disclosure are listed below:

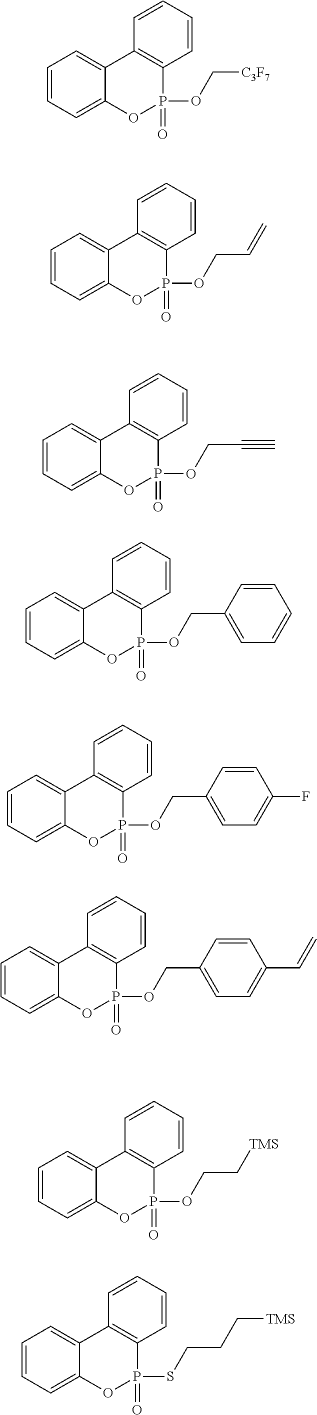

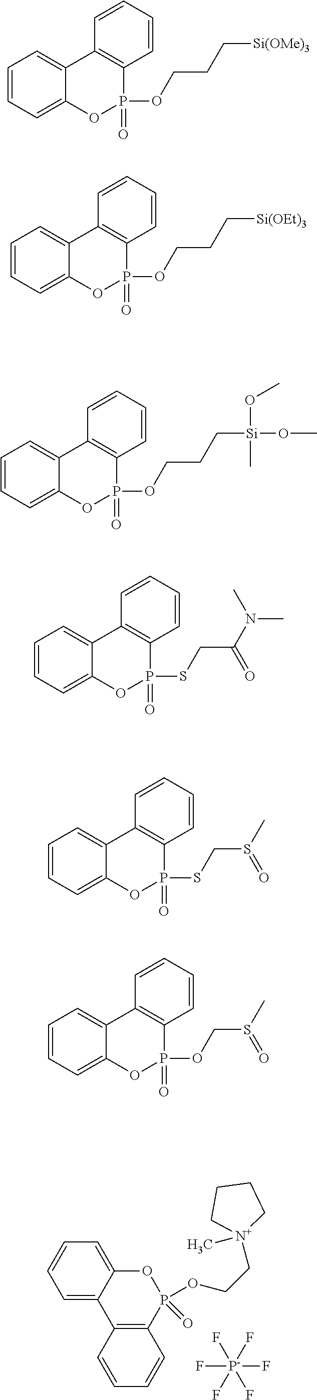

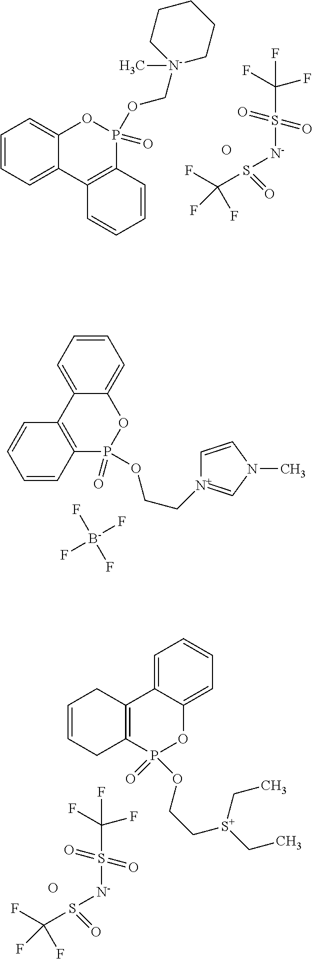

### Example D—Electrolytes for NMC622/Gr Cells

Electrolyte formulations were prepared in a dry argon filled glovebox by combining all the electrolyte components in a glass vial and stirring for 24 hours to ensure complete dissolution of the salts. The DOPO-based molecule with silyl-based groups is added to a base electrolyte formulation including a 3:7 by weight mixture of ethylene carbonate, “EC” and ethyl methyl carbonate, “EMC, and 1 M lithium hexafluorophosphate, “LiPF6”, as a Li+ ion conducting salt, dissolved therein. Conventional additives like vinylene carbonate, “VC” and fluoroethylene carbonate, “FEC” were added to the base electrolyte composition. Embodiment Example 1 (EE1) uses a representative example molecule as per the present disclosure. The electrolyte components and additives used in are summarized in Table A.

TABLE A
Electrolyte Formulations for NMC622/Gr cells

| Electrolyte | Base Formulation | Additive Weight (%) |
|---|---|---|
| Comparative Example 1 | 1.0M LiPF₆ in | VC: 1%, |
| (CE1) | EC:EMC (3:7) | FEC: 1% |
| Comparative Example 2 | 1.0M LiPF₆ in | VC: 1%, |
| (CE2) | EC:EMC (3:7) | FEC: 1%, |
| | | TMSPi: 1% |
| Embodiment Example 1 | 1.0M LiPF₆ in | VC: 1%, |
| (EE1) | EC:EMC (3:7) | FEC: 1% |
| | | Example A: 1% |
| Embodiment Example 2 | 1.0M LiPF₆ in | VC: 1%, |
| (EE2) | EC:EMC (3:7) | FEC: 1% |
| | | Example B: 1% |

### Example E—NMC622/Gr Cell Electrochemical Data

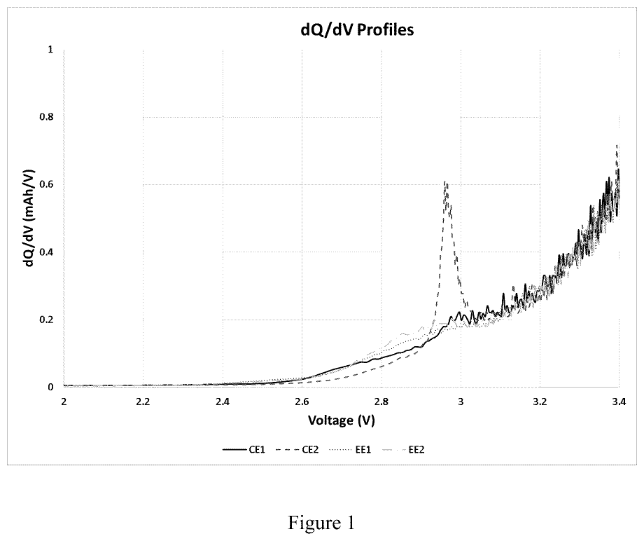

The electrolyte formulations prepared are used as electrolytes in 200 mAh Li-ion pouch cells comprising lithium nickel manganese cobalt oxide (NMC622) cathode active material and graphite as the anode active material. In each cell, 0.9 mL of electrolyte formulation was added and allowed to soak in the cell for 1 hour. The cells are vacuum sealed, and primary charged before wetting at 25° C. for 10 hours. The cells were then charged to 3.8 V at C/25 rate before degassing, followed by vacuum sealing. After degassing, the cells were charged and discharged twice between 4.45 to 3.0 V at C/10 rate, and the results are summarized in Table B. The AC-IR is the measured internal resistance at 1 kHz, and the reported discharge capacity is for the last cycle of formation at C/5 rate. Cells with all electrolytes have higher AC-IR and lower capacity values compared to CE1 which is a result of the DOPO-based molecule in the electrolyte, and the dQ/dV profiles are shown in FIG. 1.

TABLE B
Initial Cell Data for NMC622/Gr cells

| | 1^{st} Coulombic | Formation Discharge | |
|---|---|---|---|
| Electrolyte | Efficiency (%) | Capacity (mAh) | AC-IR (mΩ) |
| CE1 | 87.4 | 203.5 | 97.5 |
| CE2 | 85.7 | 199.0 | 122.3 |
| EE1 | 85.1 | 192.3 | 125.2 |
| EE2 | 83.9 | 189.3 | 120.2 |

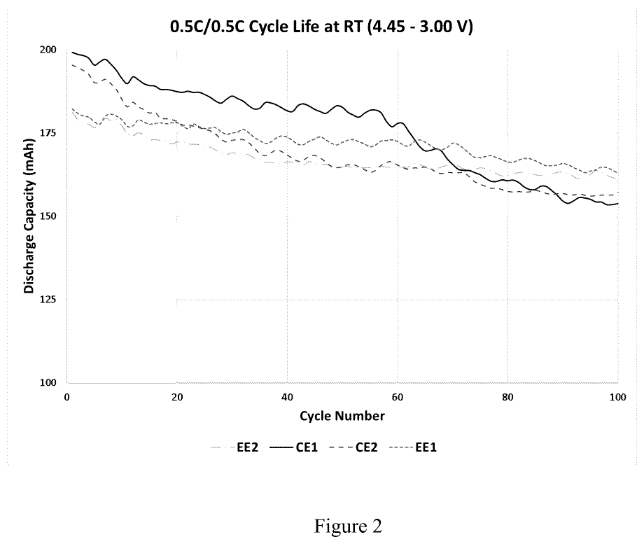

As seen in FIG. 2, the discharge capacity of cells with EE1 an EE2 electrolytes are lower than cells with CE1 and CE2 but have better capacity retention after 100 cycles at 0.5 C rate. The capacity retention values are summarized in Table C.

TABLE C
Capacity Retention data for NMC622/Gr cells

| | Capacity Retention |
|---|---|
| Electrolyte | after 100 Cycles (%) |
| CE1 | 77.2 |
| CE2 | 80.4 |
| EE1 | 89.5 |
| EE2 | 88.9 |

### Example F—Electrolytes for NMC811/Gr Cells

The DOPO-based molecule with an unsaturated terminal group is added to a base electrolyte formulation including a 3:7 by weight mixture of ethylene carbonate, “EC” and ethyl methyl carbonate, “EMC”, and 1 M lithium hexafluorophosphate, “LiPF₆”, as a Li⁺ ion conducting salt, dissolved therein. Vinylene carbonate, “VC” was used as an additional additive in the comparative example (CE3), and Embodiment Example (EE3) uses a representative example DOPO-based molecule with a propargyl group as per the present disclosure. The electrolyte components and additives in weight loadings are summarized in Table D.

TABLE D
Electrolyte Formulations for NMC811/Gr cells

| Electrolyte | Base Formulation | Additive Weight (%) |
|---|---|---|
| Comparative Example 3 | 1.0M LiPF₆ in | VC: 2%, |
| (CE3) | EC:EMC (3:7) | |
| Embodiment Example 3 | 1.0M LiPF₆ in | VC: 2%, |
| (EE3) | EC:EMC (3:7) | Example C: 0.5% |

### Example G—NMC811/Gr Cell Electrochemical Data

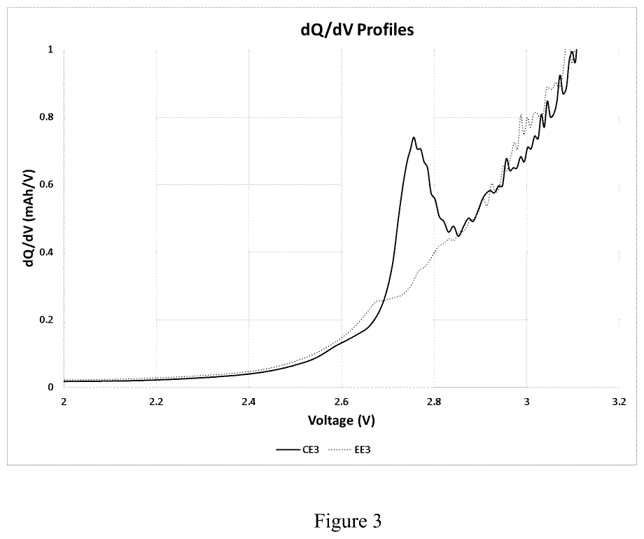

The electrolyte formulations prepared are used as electrolytes in 1.8 Ah Li-ion pouch cells comprising NMC811 cathode active material and graphite as the anode active material. The cell operation voltage window is 4.2-2.8 V. In each cell, 6 g of electrolyte was added and allowed to soak in the cell for 1 hour. The cells were vacuum sealed and allowed to rest at room temperature for 24 hours. The cells were then charged to 3.7 V at C/25 rate before degassing, followed by vacuum sealing. After degassing, the cells were charged and discharged once between 4.2 to 2.8 V at C/10 rate, and the results are summarized in Table E. The AC-IR is the measured internal resistance at 1 kHz, and the reported discharge capacity is for the last cycle of formation at C/5 rate. FIG. 3 shows the dQ/dV profiles of cell with EE3 with DOPO-based molecule as per the present disclosure, and we can see that the VC reaction is suppressed by addition of the DOPO-based molecule. The initial properties of cells with CE3 and EE3 are comparable.

TABLE E
Initial Cell Data for NMC811/Gr cells

| | 1^{st} Coulombic | Formation Discharge | |
|---|---|---|---|
| Electrolyte | Efficiency (%) | Capacity (Ah) | AC-IR (mΩ) |
| CE3 | 84.9 | 1.77 | 13.2 |
| EE3 | 85.5 | 1.78 | 13.2 |

When tested for high temperature storage, cells with EE3 show significantly lower thickness increase compared to cells with CE3, which is a result of avoiding electrolyte decomposition reactions commonly occurring at high voltages. Due to the additive Example C in EE3, the capacity retention is slightly lower than cells with CE3. The data is summarized in Table F.

TABLE F
Storage Data in NMC811/Gr cells

| | Week 0 | | Week 10 | |
|---|---|---|---|---|
| | Thickness | Capacity | Thickness | Capacity |
| Electrolyte | (%) | Retention (%) | (%) | Retention (%) |
| CE3 | 100.0 | 100.0 | 132.0 | 79.3 |
| EE3 | 100.0 | 100.0 | 125.0 | 77.5 |

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed is:

1. An electrolyte comprising:
a) an aprotic organic solvent;
b) a metal salt;
c) at least one compound according to Formula I: 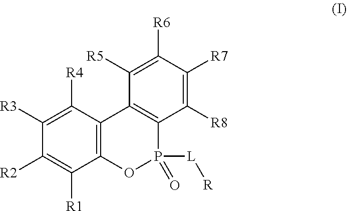
wherein:
R₁-R₈ each can be independently halogens, C₁-C₁₂ substituted and unsubstituted alkyl and fluoroalkyl groups, or C₆-C₁₄ aryl groups wherein the hydrogen atoms can be replaced by a halogen, alkyl, alkoxy, perfluorinated alkyl, silyl, siloxy, silane, sulfoxide, sulfonyl, amide, azo, ether, thioether group or combinations thereof;
L is (a) a linker, including a C₁-C₈ alkyl, alkenyl, alkynyl, alkoxy, ester, carbonyl, phenyl, thioether, sulfoxide, sulfonyl, azo or aryl group, wherein any of the carbon atoms therein are optionally further substituted with or hydrogen atoms replaced by a halide; (b) O or S; or (c) O or S attached to the linker; and
R is C₁-C₁₂ substituted or unsubstituted alkyl or fluoroalkyl groups, or C₆-C₁₄ aryl groups, wherein the hydrogen atoms can be replaced by a halogen, alkyl, alkoxy, perfluorinated alkyl, silyl, siloxy, silane, sulfoxide, sulfonyl, amide, azo, ether, thioether group or combinations thereof; or
R is C₁-C₁₂ substituted or unsubstituted alkyl fluoroalkyl groups, or C₆-C₁₄ aryl groups, terminating in an unsaturated group, wherein the hydrogen atoms can be replaced by a halogen, alkyl, alkoxy, perfluorinated alkyl, silyl, siloxy, silane, sulfoxide, sulfonyl, amide, azo, ether, thioether group or combinations thereof, or
R is a silane, where wherein the hydrogen atoms can be replaced by a halogen, alkyl, alkoxy, perfluorinated alkyl, silyl, siloxy, silane, sulfoxide, sulfonyl, amide, azo, ether, thioether group or combinations thereof, or
R is an organic cation ionically bonded to an anion, where the cation is either a sulfonium, phosphonium, or a 5- or 6-membered cationic heterocyclic ring having 1 to 3 heteroatoms as ring members including nitrogen, oxygen, silicon, or sulfur and, where the anion is either a halide, nitrate, phosphate, imide, borate, aluminate, arsenide, cyanide, thiocyanate, nitrite, benzoate, carbonate, chlorate, chlorite, chromate, sulfate, sulfite, silicate, thiosulfate, chalcogenide, pnictogenide, oxalate, acetate, formate or hydroxide.

2. The electrolyte of claim 1, wherein the compound according to Formula I is at least one of the following structures:

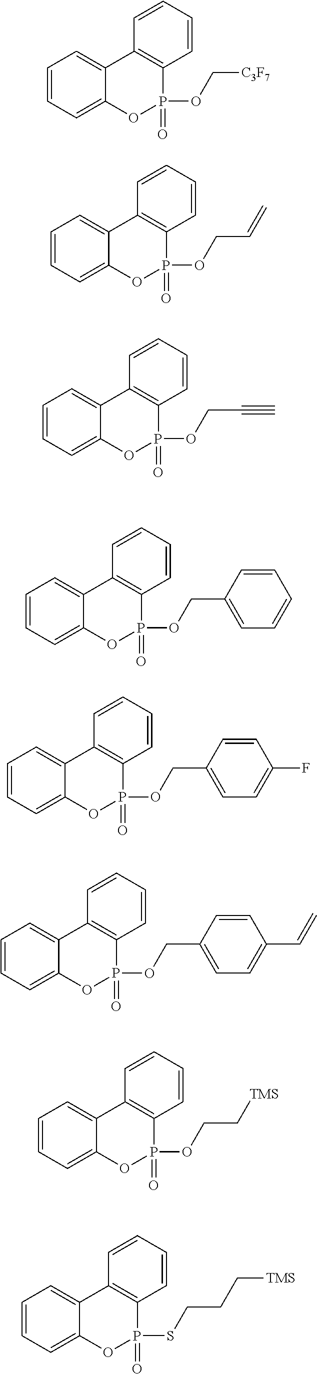

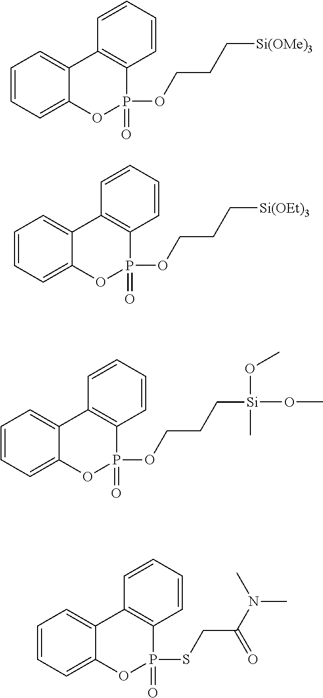

3. The electrolyte of claim 1, wherein the compound according to Formula I where R is an organic cation ionically bonded to an anion, the anion is an imidazolium, pyrrolidinium, piperidinium, or ammonium.

4. The electrolyte of claim 3, wherein the anion is either a halide, nitrate, phosphate, imide, borate, aluminate, arsenide, cyanide, thiocyanate, nitrite, benzoate, carbonate, chlorate, chlorite, chromate, sulfate, sulfite, silicate, thiosulfate, chalcogenide, pnictogenide, oxalate, acetate, formate or hydroxide.

5. The composition of claim 1, wherein the compound according to Formula I is present in a concentration of from 0.01 wt. % to 10 wt. % in the electrolyte.

6. The composition of claim 1, wherein the aprotic organic solvent comprises an open-chain or cyclic carbonate, carboxylic acid ester, nitrite, ether, sulfone, ketone, lactone, dioxolane, glyme, crown ether, siloxane, phosphoric acid ester, phosphite, mono- or polyphosphazene or mixtures thereof.

7. The composition of claim 1, wherein the aprotic organic solvent is present in a concentration of from 60 wt. % to 90 wt. % in the electrolyte.

8. The composition of claim 1, wherein the cation of the metal salt is lithium.

9. The composition of claim 1, wherein the metal salt is present in a concentration of from 10 wt. % to 30 wt. % in the electrolyte.

10. The composition of claim 1, further comprising at least one additive.

11. The composition of claim 10, wherein the at least one additive comprises a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride, epoxide, or the mixtures thereof.

12. The composition of claim 10, wherein the at least one additive is present in a concentration of 0.01 wt. % to 10 wt. % in the electrolyte.

13. An electrochemical energy storage device comprising:
a. a cathode;
b. an anode;
c. an electrolyte according to claim 1; and
d. a separator.

14. The device of claim 13, wherein the cathode is LiFePO₄, LiCoO₂, LiNiO₂, LiNiₓCo_{y}Met_{z}O₂, LiMn_{0.5}Ni_{0.5}O₂, LiMn_{0.1}Co_{0.1}Ni_{0.8}O₂, LiMn_{0.2}Co_{0.2}Ni_{0.6}O₂, LiMn_{0.3}Co_{0.2}Ni_{0.5}O₂, LiMn_{0.33}Co_{0.33}Ni_{0.33}O₂, LiMn₂O₄, LiFeO₂, Li_{1+x′}Ni_{α}Mn_{β}Co_{γ}Met′_{δ}O_{2-z′}, F_{z′}, or A_{n′}B₂(XO₄)₃, wherein Met is Al, Mg, Ti, B, Ga, Si, Mn or Co; Met′ is Mg, Zn, Al, Ga, B, Zr or Ti; A is Li, Ag, Cu, Na, Mn, Fe, Co, Ni, Cu or Zn; B is Ti, V, Cr, Fe or Zr; X is P, S, Si, W or Mo; and wherein 0≤x≤0.3, 0≤y≤0.5, 0≤z≤0.5, 0≤x′≤0.4, 0≤α≤1, 0≤β≤1, 0≤γ≤1, 0≤δ≤0.4, 0≤z′≤0.4 and 0≤h′≤3.

15. The device of claim 13, wherein the anode comprises lithium metal, graphitic material, amorphous carbon, Li₄Ti₅O₁₂, tin alloy, silicon, silicon alloy, intermetallic compound, or mixtures thereof.

16. The device of claim 13, wherein the separator comprises an electron beam-treated micro-porous polyolefin separator or a microporous polymer film comprising nylon, cellulose, nitrocellulose, polysulfone, polyacrylonitrile, polyvinylidene fluoride, polypropylene, polyethylene, polybutene, or co-polymers or blends of any two or more such polymers.

17. The device of claim 13, wherein the aprotic organic solvent comprises an open-chain or cyclic carbonate, carboxylic acid ester, nitrite, ether, sulfone, ketone, lactone, dioxolane, glyme, crown ether, siloxane, phosphoric acid ester, phosphite, mono- or polyphosphazene or mixtures thereof.

18. The device of claim 13, wherein the cation of the metal salt is lithium.

19. The device of claim 13, where the electrolyte of claim 1 further comprises at least one additive.

20. The device of claim 19, wherein the at least one additive comprises a sulfur-containing compound, phosphorus-containing compound, boron-containing compound, silicon-containing compound, fluorine-containing compound, nitrogen-containing compound, compound containing at least one unsaturated carbon-carbon bond, carboxylic acid anhydride, epoxide or the mixtures thereof.
